(19) United States
(12) Patent Application Publication
(10) Pub. No.: US 2013/0047604 A1
(43) Pub. Date: Feb. 28, 2013

(54) INTERNAL COMBUSTION ENGINE AND METHOD FOR OPERATING INTERNAL COMBUSTION ENGINE

(71) Applicants: Steven J. Andrasko, Wixom, MI (US); Christopher J. Kalebjian, Columbus, MI (US); Bryan A. Kuieck, Estero, FL (US); Yun Xiao, Ann Arbor, MI (US); Thomas L. Bahensky, Plymouth, MI (US)

(72) Inventors: Steven J. Andrasko, Wixom, MI (US); Christopher J. Kalebjian, Columbus, MI (US); Bryan A. Kuieck, Estero, FL (US); Yun Xiao, Ann Arbor, MI (US); Thomas L. Bahensky, Plymouth, MI (US)

(73) Assignee: GM GLOBAL TECHNOLOGY OPERATIONS LLC, Detroit, MI (US)

(21) Appl. No.: 13/219,819

(22) Filed: Aug. 29, 2011

(51) Int. Cl. F02B 37/00; F02B 37/16; F01N 3/021; F02B 37/04

(52) U.S. Cl. 60/600; 60/605.2; 60/602

(57) ABSTRACT

In one exemplary embodiment of the invention, an internal combustion engine includes a turbocharger configured to receive an air flow and a first exhaust flow from the internal combustion engine and a supercharger downstream of the turbocharger configured to receive a compressed air charge from the turbocharger. The engine further includes an exhaust gas recirculation circuit receiving a second exhaust flow from the internal combustion engine and supplying the second exhaust flow to the compressed air charge upstream of the supercharger, wherein the second exhaust flow and compressed air charge comprise an exhaust-air mixed flow received by the internal combustion engine.

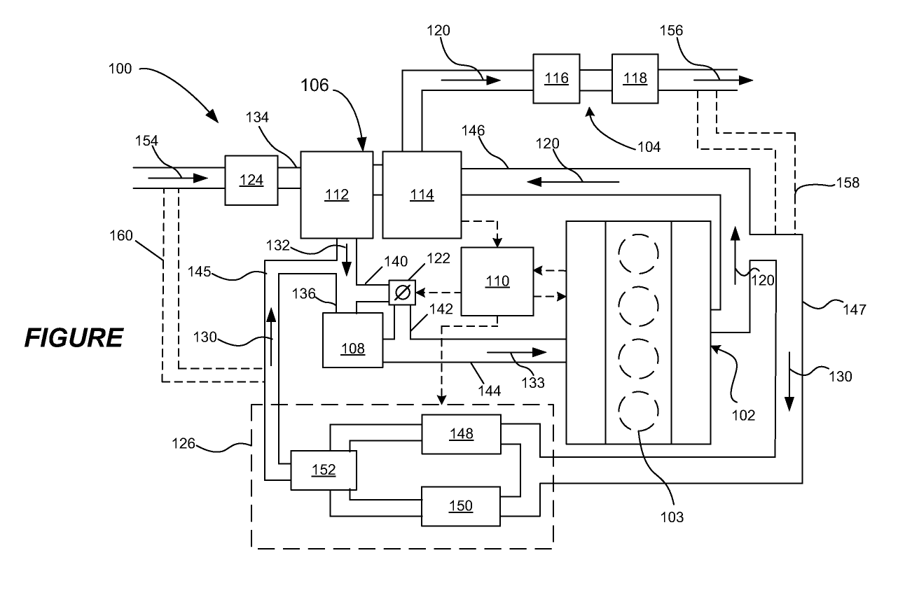

### FIELD OF THE INVENTION

The subject invention relates to internal combustion engines, and, more particularly, to turbochargers, superchargers and air induction systems for internal combustion engines.

### BACKGROUND

The efficient use of exhaust gas recirculation (EGR) is important to internal combustion engines, including both gasoline and diesel engines. Efficient use of EGR generally supports the objectives of realizing high power output from these engines while also achieving high fuel efficiency and achieving increasingly stringent engine emission requirements. The use of forced-induction apparatus, particularly including turbochargers and superchargers, in these engines is frequently employed to increase the engine intake mass airflow and the power output of engines with lower displacements.

Turbochargers are powered by exhaust gas, so the efficient use of EGR and forced-induction from turbochargers necessitates synergistic design of these systems. The time required to bring the turbocharger up to a speed where it can provide increased air pressure, or boost, to the air intake is called turbo lag. The turbo lag is caused by the time used by the exhaust system to drive the turbine to come to a higher pressure and for the turbine rotor to overcome its rotational inertia and reach the speed necessary to supply boost pressure. Superchargers include a directly-driven compressor which does not experience the lag that affects turbochargers. However, superchargers are mechanically driven by the engine itself, thereby consuming power in order to produce power, which can be less efficient than a turbocharger during some operating conditions.

In addition, when EGR systems are integrated with forced-induction systems, optimal performance of the engine at lower load conditions may utilize more recirculated exhaust than the system is capable of providing, due to limitations such as a turbocharger compressor low load surge limit (or “surge line”) at which air flow to the engine stalls, thereby reducing performance and efficiency at lower loads. In the embodiments, the turbocharger boost is limited by the surge limit to avoid damage to the turbocharger at lower loads.

### SUMMARY OF THE INVENTION

In one exemplary embodiment of the invention, an internal combustion engine includes a turbocharger configured to receive an air flow and a first exhaust flow from the internal combustion engine and a supercharger downstream of the turbocharger configured to receive a compressed air charge from the turbocharger. The engine further includes an exhaust gas recirculation circuit receiving a second exhaust flow from the internal combustion engine and supplying the second exhaust flow to the compressed air charge upstream of the supercharger, wherein the second exhaust flow and compressed air charge comprise an exhaust-air mixed flow received by the internal combustion engine.

In another exemplary embodiment of the invention, a method for operating an internal combustion engine includes receiving an air flow in a turbocharger, receiving a first exhaust flow from the internal combustion engine in the turbocharger and receiving a compressed air charge from the turbocharger in a supercharger positioned downstream of the turbocharger. The method also includes directing a second exhaust flow from the internal combustion engine to mix with the compressed air charge upstream of the supercharger, wherein the second exhaust flow and compressed air charge comprise an exhaust-air mixed flow received by the internal combustion engine.

The above features and advantages, and other features and advantages of the invention are readily apparent from the following detailed description when taken in connection with the accompanying drawings.

### BRIEF DESCRIPTION OF THE DRAWING

Other objects, features, advantages and details appear, by way of example only, in the following detailed description of embodiments, the detailed description referring to the drawing in which:

The Figure is a schematic diagram of an embodiment of an internal combustion engine.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, the Figure is a schematic that illustrates an exemplary internal combustion engine 100 including an engine block 102, an exhaust system 104, a turbocharger 106, a supercharger 108 and a controller 110. The internal combustion engine 100 may be any suitable diesel or gasoline engine. The engine block 102 includes cylinders 103 that receive a combination of combustion air and fuel. The combustion air/fuel mixture is combusted resulting in reciprocation of pistons (not shown) located in the cylinders. The reciprocation of the pistons rotates a crankshaft (not shown) to deliver motive power to a vehicle powertrain (not shown) or to a generator or other stationary recipient of such power (not shown) in the case of a stationary application of the internal combustion engine 100. The combustion of the air/fuel mixture causes an exhaust gas flow 120 through the turbocharger 106 and into the exhaust system 104. In an embodiment, the turbocharger 106 includes a compressor 112 and a turbine 114 coupled by a shaft (not shown) rotatably disposed in the turbocharger 106. The exhaust gas flow 120 is communicated from the engine block 102 through a passage 146 to drive the turbine 114.

The exhaust system 104 may include an oxidation catalyst 116 and a particulate filter 118 as well as additional exhaust treatment system components. Exhaust gas 120 flows through the exhaust system 104 for removal and/or reduction of pollutants before release into the atmosphere. In an exemplary internal combustion engine 100, the controller 110 is in signal communication with the turbocharger 106, a supercharger bypass 122, an air intake 124, and an exhaust gas recirculation (EGR) system 126. The controller may also be coupled to sensors, such as one or more manifold pressure sensors (not shown). The controller 110 is configured to use various signal inputs to control various processes, such as a flow of recirculated exhaust 130 into a compressed air charge 132 received by the supercharger 108. In an embodiment, the controller 110 is coupled to and controls the supercharger bypass 122 and the turbocharger 106 to provide boost and power to the engine across low and high engine loads. As used herein, the term controller refers to an application specific integrated circuit (ASIC), an electronic circuit, a processor (shared, dedicated or group) and memory that executes one or more software or firmware programs, a combinational logic circuit, and/or other suitable components that provide the described functionality.

The air intake 124 receives a fresh air 154 flow that is received by the compressor 112 via a passage 134, wherein the compressor 112 creates a compressed air charge 132 that communicates along a passage 136 to the supercharger 108. As depicted, the supercharger bypass 122 includes a valve and passage that selectively enables direct communication of the compressed air charge 132 through passages 140 and 142, to the engine block 102 via a passage 144. In addition, the EGR system 126 supplies recirculated exhaust 130 that flows through passage 145. The recirculated exhaust 130 is added to the compressed air charge 132 in passage 136 to resulting in an exhaust-air mixed flow 133.

As depicted, a portion of the exhaust gas 120 is diverted as recirculated exhaust 130 which flows through a passage 147 to the EGR system 126. In embodiments, the EGR system 126 also includes suitable components for treating and controlling flow of the recirculated exhaust 130. Exemplary components of the EGR system 126 may include a cooler 148, a bypass 150 and a valve 152. The cooler 148 may be any suitable device for exchanging heat, such as a fluid-based heat exchanger. In an embodiment, the bypass 150 includes a valve and passage that enable recirculated exhaust 130 to flow directly to the valve 152, without cooling by the cooler 148. Alternatively, the cooler 148 removes heat from the recirculated exhaust 130 to provide cooled exhaust to be mixed with the compressed air charge 132 to improve combustion performance. Embodiments of the EGR system 126 may include any suitable components arranged in a manner to provide recirculated exhaust suitable for mixing with air to improve combustion of the engine. In an embodiment, the valve 152 may be an assembly that includes a filter to remove particulates from the recirculated exhaust 130 to reduce contamination of the fresh air 154 by particulate matter, thereby improving combustion.

In an embodiment, the exhaust gas 120 flows from the turbine 114 into the oxidation catalyst 116 and the particulate filter 118. A treated exhaust 156, with reduced amounts of regulated constituents, flows from the particulate filter 118 into the atmosphere. In one embodiment, the treated exhaust 156 is used to supply the EGR system 126 with recirculated exhaust 130 via a passage 158. The embodiment improves combustion due to reduced particles and other exhaust constituents in the recirculated exhaust 130 mixed with the compressed air charge 132. When supplied by the treated exhaust 156, the recirculated exhaust 130 is a relatively lower pressure fluid flow as compared to the exhaust flow directly from the engine block 102. Accordingly, the embodiment of recirculated exhaust 130 supplied via passage 158 is lower pressure than the embodiment of recirculated exhaust 130 supplied from passage 146. As depicted, the arrangement of the turbocharger 106, the EGR system 126 and the supercharger 108 enable the supercharger 108 to act as a pump to draw the recirculated exhaust 130 into the compressed air charge 132. Further, the supercharger 108 acts as a mixer to mix the recirculated exhaust 130 with the compressed air charge 130, further improving the combustion process and reducing emissions.

In an embodiment, recirculated exhaust 130 may be directed through a passage 160 to mix with fresh air 154 prior to entering the turbocharger 106. The embodiment directs the recirculated exhaust 130 into the fresh air 154, wherein the mixture is then compressed within the turbocharger 106 and directed into passage 136. In one embodiment, the configuration using EGR supplied from the passage 158 may be used with the passage 160 for mixing with the fresh air. In another embodiment, the passage 158 is utilized in combination with the passage 145 to direct the recirculated exhaust 130 with compressed air charge 132. In embodiments, where the supercharger 108 is not positioned to act as a pump for recirculated exhaust flow 130, valves may be used to cause pressure differences to control flow of EGR exhaust. In the depicted embodiment, the arrangement of the EGR system 126 and the supercharger 108 enable improved emissions reduction for the internal combustion engine 100.

By positioning the supercharger 108 downstream (with respect to the air flow) of the compressor 112, the size of the supercharger 108 may be substantially reduced, thereby improving engine packaging. The supercharger 108 receives pre-pressurized compressed air charge 132, which is also denser compared to uncompressed fresh air 154. In an embodiment, the supercharger 108 may operate during periods of lower load, such as directly after start up of the engine, when the turbine 114 is not sufficiently driven by exhaust flow 120. Thus, during the lower load periods, the supercharger 108 provides compressed air to the engine block 102 to compensate for the reduced compressed air from the turbocharger 106. The supercharger 108 boost reduces the effect of “turbo lag,” such as when the turbine 114 is not sufficiently driven during a transient or low load condition where exhaust power is too low to sufficiently accelerate the turbine 114. At increased loads, the turbocharger 106 provides sufficient boost and the supercharger bypass 122 may enable the compressed air charge to bypass the supercharger 108. The arrangement provides a smooth or consistent power delivery for the internal combustion engine 100 while improving efficiency with the EGR system 126 integrated with the supercharger 108 and turbocharger 106 configurations. In an embodiment, the supercharger bypass 122 may act as a recirculation valve depending on pressures within the system, wherein the bypass enables compressed air to be recirculated back to the supercharger inlet to minimize pressure rise.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. An internal combustion engine comprising:
a turbocharger configured to receive an air flow and a first exhaust flow from the internal combustion engine;
a supercharger downstream of the turbocharger configured to receive a compressed air charge from the turbocharger; and
an exhaust gas recirculation circuit receiving a second exhaust flow from the internal combustion engine and supplying the second exhaust flow to the compressed air charge upstream of the supercharger, wherein the second exhaust flow and compressed air charge comprise an exhaust-air mixed flow received by the internal combustion engine.

2. The internal combustion engine of claim 1, comprising a supercharger bypass valve to enable the exhaust-air mixed flow to bypass the supercharger and flow directly to the internal combustion engine.

3. The internal combustion engine of claim 2, comprising a controller coupled to the supercharger bypass valve to control flow of the exhaust-air mixed flow.

4. The internal combustion engine of claim 1, wherein the supercharger mixes the exhaust-air mixed flow to improve combustion performance for the internal combustion engine.

5. The internal combustion engine of claim 1, wherein the exhaust gas recirculation circuit comprises a filter to remove particulates in the second exhaust flow mixed with the compressed air charge.

6. The internal combustion engine of claim 1, wherein the supercharger draws the second exhaust flow into the compressed air charge.

7. The internal combustion engine of claim 1, wherein the exhaust gas recirculation circuit comprises an exhaust gas recirculation cooler, a cooler bypass valve and an exhaust gas recirculation flow valve.

8. An internal combustion engine comprising:
a turbocharger configured to receive a fresh air flow and a first exhaust flow from the internal combustion engine;
a supercharger downstream of the turbocharger configured to receive a compressed air charge from the turbocharger; and
a supercharger bypass passage and a supercharger bypass valve to enable the compressed air charge to bypass the supercharger and flow into the internal combustion engine.

9. The internal combustion engine of claim 8, comprising a valve to control flow of the compressed air charge through the supercharger.

10. The internal combustion engine of claim 8, comprising an exhaust gas recirculation circuit configured to deliver an exhaust flow to the compressed air charge upstream of the supercharger, wherein the exhaust flow and the compressed air charge comprise an exhaust-air mixed flow for delivery to the internal combustion engine.

11. The internal combustion engine of claim 8, comprising an exhaust gas recirculation circuit configured to receive exhaust gas downstream of the turbocharger, wherein the exhaust gas recirculation circuit supplies a recirculation exhaust gas to mix with the fresh air flow upstream of the turbocharger.

12. The internal combustion engine of claim 8, comprising an exhaust gas recirculation circuit configured to receive exhaust gas downstream of the turbocharger, wherein the exhaust gas recirculation circuit supplies a recirculation exhaust gas to mix with the compressed air charge upstream of the supercharger, wherein the recirculation exhaust flow and compressed air charge comprise an exhaust-air mixed flow for delivery to the internal combustion engine.

13. A method for operating an internal combustion engine, the method comprising:
receiving an air flow in a turbocharger;
receiving a first exhaust flow from the internal combustion engine in the turbocharger;
receiving a compressed air charge from the turbocharger in a supercharger positioned downstream of the turbocharger; and
directing a second exhaust flow from the internal combustion engine to mix with the compressed air charge upstream of the supercharger, wherein the second exhaust flow and compressed air charge comprise an exhaust-air mixed flow received by the internal combustion engine.

14. The method of claim 14, comprising bypassing the supercharger via a supercharger bypass valve to flow the compressed air charge directly to the internal combustion engine.

15. The method of claim 15, comprising controlling flow through the supercharger valve via a controller.

16. The method of claim 16, wherein the controller is coupled to the turbocharger and internal combustion engine to determine a position of the supercharger bypass valve.

17. The method of claim 14, wherein directing the second exhaust flow comprises directing the second exhaust flow through a filter to remove particulates in the second exhaust flow mixed with the compressed air charge.

18. The method of claim 14, wherein the supercharger in operation draws the second exhaust flow into the compressed air charge.

19. The method of claim 14, wherein directing the second exhaust flow comprises directing the second exhaust flow through an exhaust gas recirculation flow valve and one of an exhaust gas recirculation cooler and a cooler bypass valve.
